(19) United States
(12) Patent Application Publication
(10) Pub. No.: US 2006/0238055 A1
(43) Pub. Date: Oct. 26, 2006

(54) Magnetic motor

(76) Inventor: Tiras J. Danford, Leesburg, GA (US)

Correspondence Address: The Law Offices of Kenneth W. Float, 2095 Hwy. 211 NW, #2F, Braselton, GA, 30517, US

(21) Appl. No.: 11/112,706

(22) Filed: Apr. 23, 2005

(51) Int. Cl. H02K 21/12; H02K 7/10; H02P 9/04

(52) U.S. Cl. 310/156.01; 310/75 R; 290/1 R

(57) ABSTRACT

Power generating apparatus comprising a permanent magnet motor that embodies movable permanent magnets and fixed electromagnets aligned in a linear fashion to generate a continuous magnetic field. The permanent magnets provide for an energy source whose energy may be harvested. Polarities of the electromagnets are switched by switching circuitry to alternately change their polarity from north (N) to south (S) and vice-versa. This causes motion of the permanent magnets in a reciprocating fashion due to the alternating attractive and repelling forces that exist when the adjacent poles of the magnets are opposed or the same. The moving permanent magnets cause reciprocating motion of a power shaft to provide output energy. The power shaft may be mechanically linked to a cam assembly of an drive shaft so that reciprocating motion of the permanent magnets causes rotary motion of the drive shaft. The power generating apparatus generates more output power than input power necessary to energize the electromagnets.

### BACKGROUND

The present invention relates generally to power generating apparatus, and more particularly, to magnetic power generating apparatus, such as a magnetic motor, employing multiple movable permanent magnets and multiple fixed electromagnets that converts magnetic energy into mechanical energy.

As is outlined in U.S. Pat. No. 3,935,487, motors have heretofore been developed that use movable permanent magnets with stationary electrically energized windings or stationary permanent magnets with movable electrically energized windings. The windings may be energized from a direct current source, such as a battery, and the energy is commutated to reverse the polarity of fields created by the windings or to interrupt the fields to produce relative motion between the permanent magnets and the windings. Other exemplary magnetic motors are disclosed in U.S. Pat. Nos. 1,724,446, 1,859,643, 1,863,294, 3,670,189, 3,703,653, 3,811,058 and 5,455,474.

### BRIEF DESCRIPTION OF THE DRAWINGS

The various features and advantages of the present invention may be more readily understood with reference to the following detailed description taken in conjunction with the accompanying drawing figure, wherein like reference numerals designate like structural elements, and in which:

FIG. 1 illustrates one exemplary embodiment of power generating apparatus in accordance with the principles of the present invention;

FIG. 1a illustrates a basic exemplary embodiment of power generating apparatus in accordance with the principles of the present invention;

FIG. 1b illustrates another exemplary embodiment of power generating apparatus in accordance with the principles of the present invention;

FIG. 2 is an enlarged top view of a portion of the power generating apparatus shown in FIG. 1;

FIG. 3 is an enlarged side view of the portion of the power generating apparatus shown in FIG. 2;

FIG. 4 illustrates an enlarged view of power source and control components of the power generating apparatus;

FIGS. 5a and 5b are side and top views, respectively, showing components of the apparatus used to couple a power shaft driven by magnets to a drive shaft;

FIG. 6 is a side view of an exemplary linkage that may be used in the power generating apparatus;

FIGS. 7a and 7b are a chart relating to input power supplied to exemplary embodiments of the power generating apparatus;

FIG. 8 is a chart relating to output power generated by exemplary embodiments of the power generating apparatus; and

FIG. 9 is a graph showing RPM versus horsepower (HP) for different size permanent magnet and coil configurations.

### DETAILED DESCRIPTION

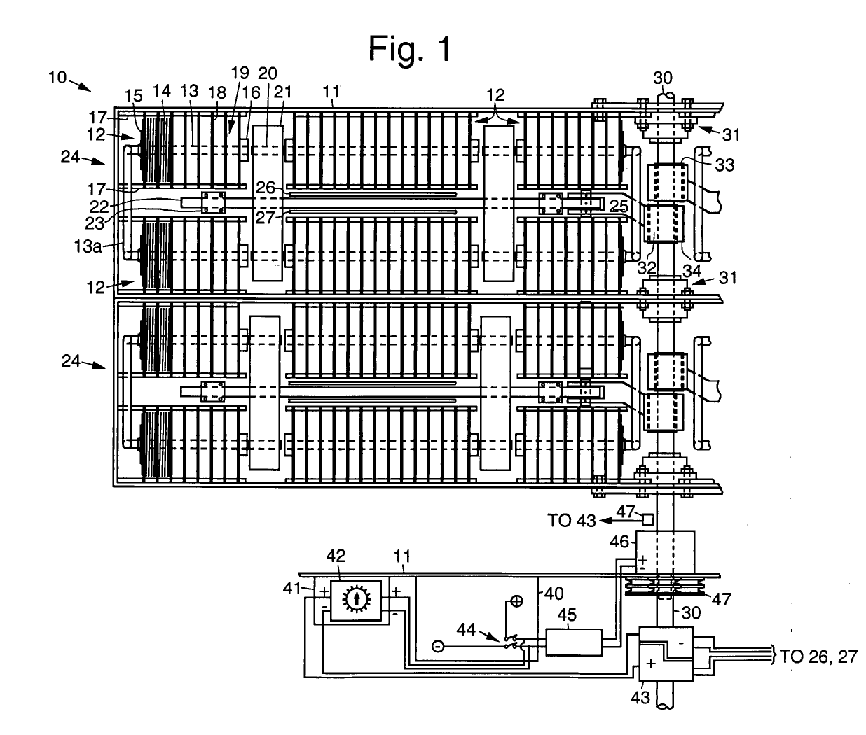

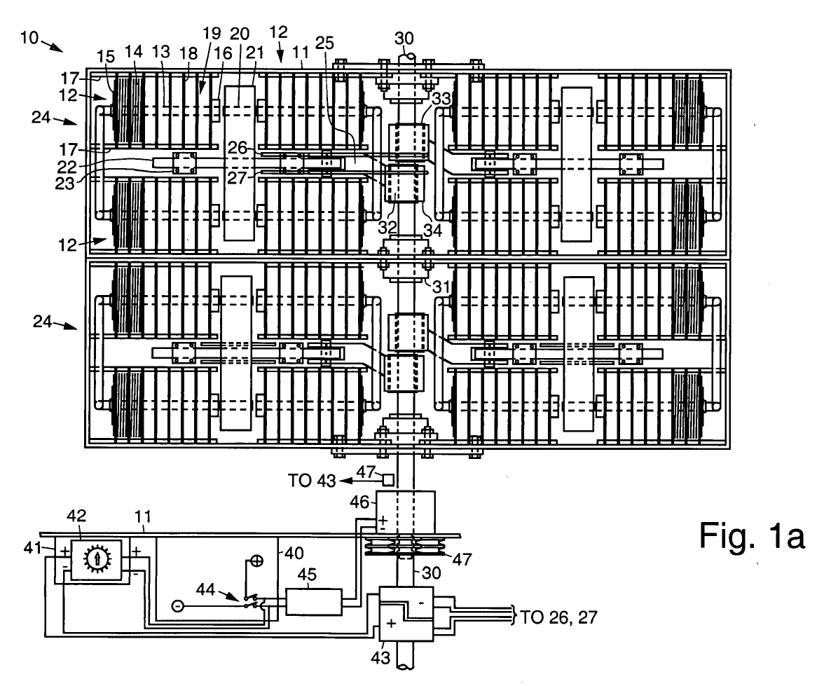

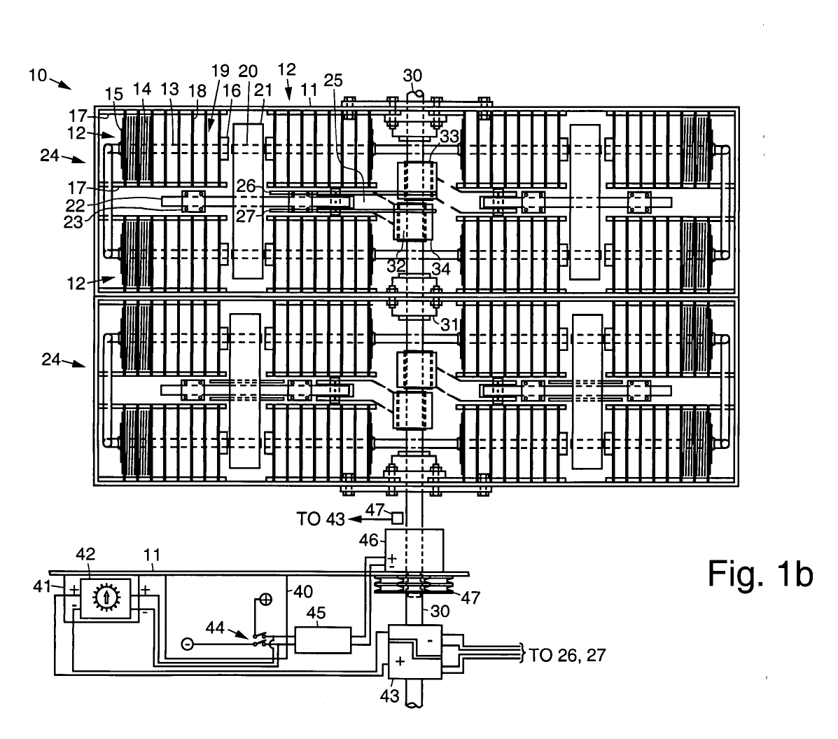

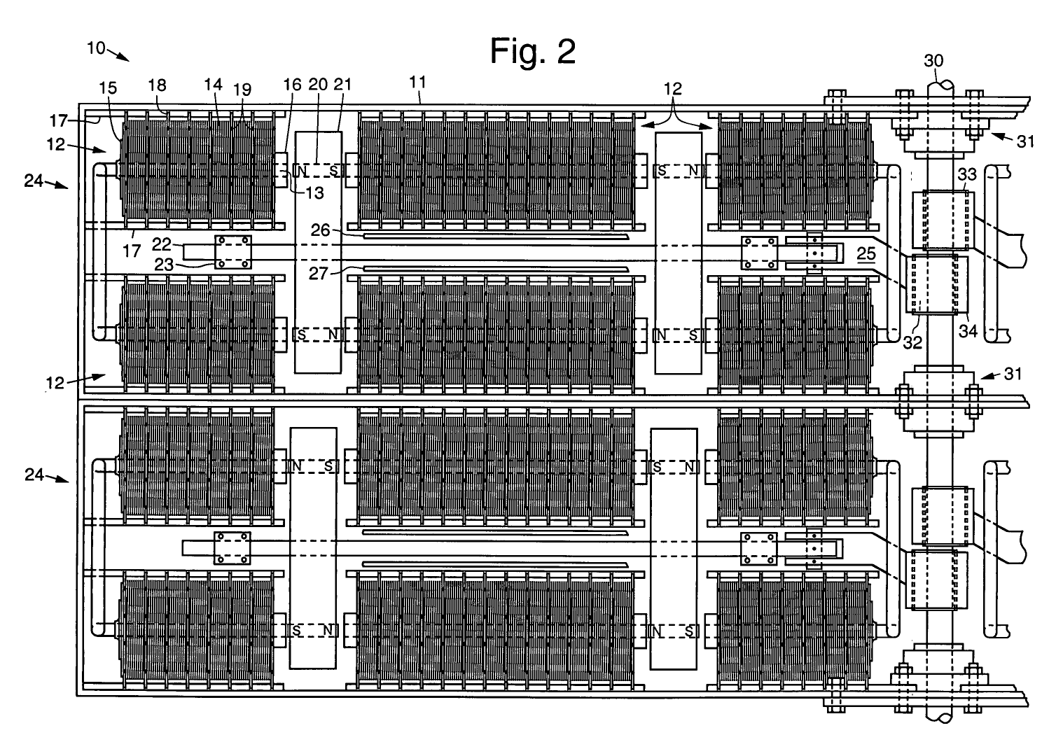

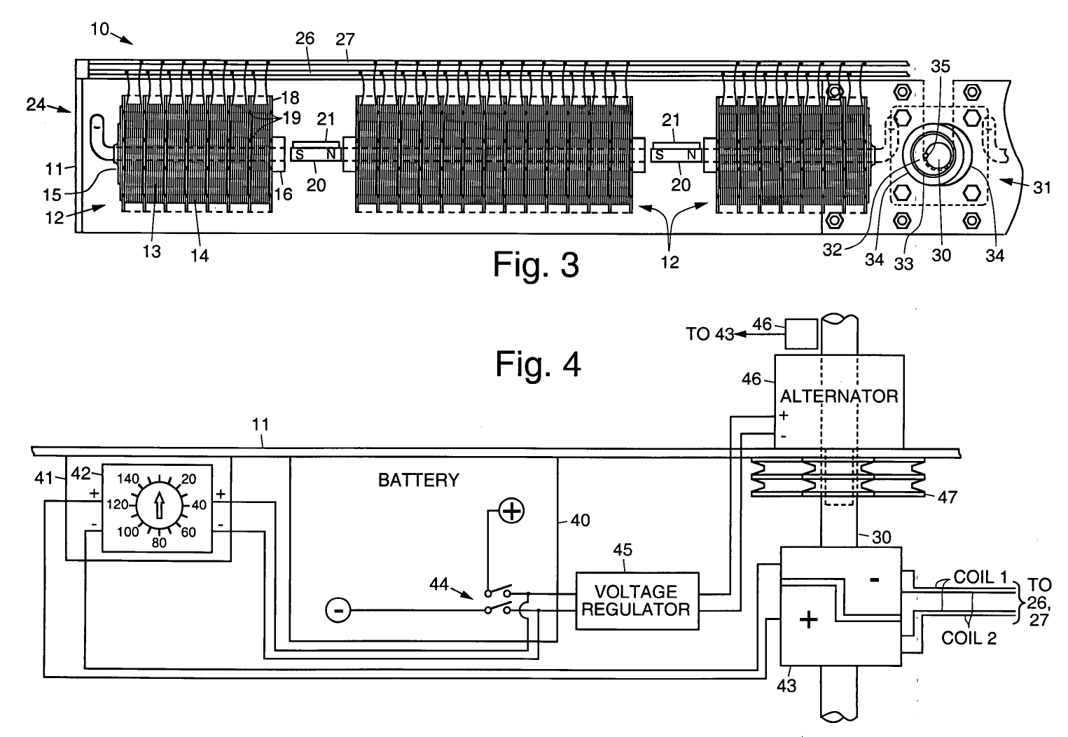

Referring to the drawing figures, FIG. 1 illustrates a first exemplary embodiment of power generating apparatus 10, or magnetic motor 10, in accordance with the principles of the present invention. FIGS. 2 and 3 show enlarged top and side views, respectively, of a portion of the power generating apparatus 10 shown in FIG. 1, while FIG. 4 is an enlarged view showing power source and control components of the power generating apparatus 10.

FIG. 1a illustrates a second exemplary embodiment of power generating apparatus 10, or magnetic motor 10. The power generating apparatus 10 shown in FIG. 1a is a basic embodiment of the present invention. The power generating apparatus 10 shown in FIG. 1a comprises four magnetic circuits 24. FIG. 1b illustrates another exemplary embodiment of power generating apparatus 10, or magnetic motor 10. The power generating apparatus 10 shown in FIG. 1b comprises two magnetic circuits 24.

As is shown in FIGS. 1-3, the exemplary power generating apparatus 10 comprises a nonmagnetic housing 11, which may be made of aluminum or stainless steel, or other desirable nonmagnetic material, for example. A plurality of movable permanent magnets 20 are interposed between a plurality of fixed electromagnets 12 to form a closed magnetic circuit 24. The movable permanent magnets 20 may be comprised of a rare earth material, such as Neodymium (Nd) or Samarium (Sm) for example. The permanent magnets 20 provide for an energy source whose energy may be harvested.

FIGS. 1 and 2 show two such magnetic circuits 24. However, it is to be understood that a greater number of such magnetic circuits 24 may be disposed adjacent to those magnetic circuits 24 that are shown to form a linear multi-dimensional array of magnetic circuits 24. Furthermore, it is to be understood that additional layers of magnetic circuits 24 may be disposed (i.e., stacked) above or below the magnetic circuits 24 shown in FIGS. 1 and 2 to form a multi-dimensional array of magnetic circuits 24. In addition, magnetic circuits 24 are disposed on both sides of an output drive shaft 30 of the power generating apparatus 10.

Outermost fixed electromagnets 12 are each comprised of a U-shaped core 13 around which multiple subcoils 14 of electrical wire are wound. FIG. 1 only shows two subcoils 14 at the left side of the magnetic circuits 24, so that other components of the apparatus 10 may be more clearly shown. FIG. 2 shows that the multiple subcoils 14 are wound around substantially the full working lengths of the fixed electromagnets 12.

The individual subcoils 14 are separated by spacers 18 having heat dissipating channels 19 or spaces 19 therein. The heat dissipating channels 19 or spaces 19 allow air to flow between the subcoils 14 to remove heat. The subcoils 14 and spacers 18 are axially held together using retainers 15, 16 on either side of the stack of subcoils 14 and spacers 18. The subcoils 14 and spacers 18 are also secured by means of retainers 17 that are coupled to the housing 11.

Each of the subcoils 14 are connected to two bus bars 26, 27, which connections are more clearly shown in FIG. 3. The wires of the respective subcoils 14 may be mechanically fastened or otherwise electrically attached to the respective bus bars 26, 27. The bus bars 26, 27 may be located at any convenient location within the housing 11 adjacent to the subcoils 14 that allows for ease of wiring.

Each magnetic circuit 24 in the exemplary embodiment is shown having four movable permanent magnets 20. However, it is to be understood that a greater or lesser number of movable permanent magnets 20 may be interposed between the same number of fixed electromagnets 12 to change the length of the respective magnetic circuits 24. Adjacent movable permanent magnets 20 are physically coupled together by means of a linkage 21 that is attached to an elongated power bar 22 that is fixed to a coupling 31 having an exterior cam 32 secured to the drive shaft 30.

With reference to FIGS. 1 and 2, the lowest cam 32 on the drive shaft 30 may have its lobe aligned at 0°, the next higher cam 32 may have its lobe aligned at 180°, the next higher cam 32 may have its lobe aligned at 90°, and the highest cam 32 may have its lobe aligned at 270°, for example.

All laterally adjacent permanent magnets 20 in a closed circuit (such as at the left side of FIGS. 1-3) have their north and south poles facing in the opposite direction. The next set of laterally adjacent movable permanent magnets 20 that are disposed along the magnetic circuit 24 (such as are shown at the right side of FIGS. 1-3) have their north and south poles lying in the same magnetic path with poles that are magnetically disposed opposite to the preceding set of movable permanent magnets 20.

The sum of the air gaps between one of the movable permanent magnets 20 and the adjacent fixed electromagnets 12 constantly changes and varies from 0.08 inches minimum to 0.5 inches maximum in this embodiment. It is preferred that the maximum sum of the combined space between both ends of a movable permanent magnet 20 and the ends of the adjacent fixed electromagnets 12 be less than one-half the length of the movable permanent magnets 20.

The fixed electromagnets 12 are controlled and energized so that adjacent electromagnets 12 have opposite polarities. The fixed electromagnets 12 are controlled and energized so that their polarities are alternated in a manner that alternately attracts and repels the interposed movable permanent magnets 20. Thus, by reversing the current flow through the subcoils 14, the fixed electromagnets 12 influence the movable permanent magnets 20 which are moved to the left and right to cause linear reciprocating motion thereof, and hence linear reciprocating motion of the linkage 21 attached thereto. Since the linkage 21 is attached to the power shaft 22

Switching the direction of the current flow, or polarity of the fixed electromagnets 12 may be controlled by the commutator 43 or using a photo-switch 47 or an electronic switching device 47, for example. Rotation of the drive shaft 30 triggers the commutator 43, the photo-switch 47, or the electronic switching device 47 to switch the direction of the current flow through the subcoils 14 and thus switch the polarity of the fixed electromagnets 12. The commutator 43, the photo-switch 47, or the electronic switching device 47 may be located on or near the drive shaft 30, for example.

Alternatively, if the power generating apparatus 10 is configured to operate to generate reciprocating motion (i.e., does not employ a drive shaft 30), so as to drive a piston, for example, the photo-switch 47 or electronic switching device 47 may be located adjacent to the linkage 21, for example, whose movement may be used to trigger switching of the polarities of the fixed electromagnets 12.

The linkage 21 is attached to a movable power shaft 22. The movable power shaft 22 is slidable relative to the housing 11 along the axis of the magnetic circuits 24. The movable power shaft 22 may be supported by bearings that may be attached to the housing 11 using bearing blocks 23, for example.

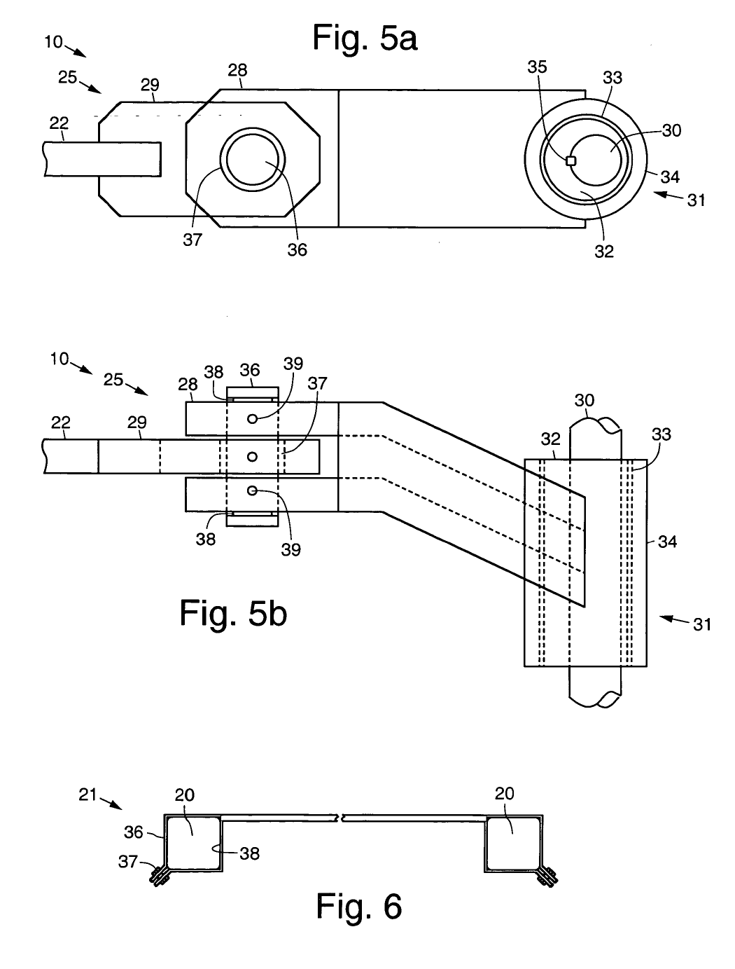

The movable power shaft 22 is coupled by way of a flexible joint 25 to the drive shaft 30. Details of the flexible joint 25 are shown in FIGS. 5a and 5b. As is shown in FIGS. 5a and 5b, the power shaft 22 has one end attached, such as by welding) to a power shaft bar 29. The power shaft bar 29 is coupled to a cam frame 28 using a pivot pin 36, for example,. A needle bearing 37, for example, is disposed in the power shaft bar 29 that holds the pivot pin 36. The pivot pin 36 is secured to the cam frame 28 using set screws 39, for example. The pivot pin 36 is secured to the cam frame 28 using snap rings 38, for example. A grease fitting 39a may be provided for lubricating the needle bearing 37.

The flexible joint 25 is coupled to a cam assembly 31. The cam assembly 31 comprises a cam 32, a bearing 33 or bushing 33, a cam housing 34, and the cam frame 28. The end of the cam frame 28 distal from the power shaft 22 contacts the cam housing 34. The cam 32 is keyed to the drive shaft 30. The bearing 33 or bushing 33, is disposed between the cam 32 and the cam housing 34 and allows the cam housing 34 to rotate relative to the drive shaft 30. A plurality of cam assemblies 31 are provided, one or more for each magnetic circuit 24.

Referring now to FIG. 4, it illustrates an enlarged view of power source and control components of the power generating apparatus 10, which are generally shown in FIG. 1. The power source and control components of the power generating apparatus 10 comprise a voltage source 40, such as a battery 40, or fuel cell 40, which is coupled to a double pole, single throw switch 44. The voltage source 40, by way of the switch 44, is coupled to a voltage regulator 42 housed in a junction box 41. The voltage regulator 42 is coupled to a commutator 43, for example. Outputs of the commutator 43 are coupled to the bus bars 26, 27. An alternator 46 is coupled to the drive shaft 30 and is connected by way of a voltage regulator 45 to the switch 44. Hence, the alternator 46 is selectively coupled to the battery 40 and the voltage regulator 42 by way of the switch 44. As is shown in FIG. 4, a pulley system 47 is coupled to the drive shaft 30 which allows continuous generation of electrical power to supply the subcoils 14 with excess power to be selectively used.

FIG. 6 is a side view of an exemplary linkage 21 that may be used in the power generating apparatus 10. The exemplary linkage 21 has clamps 36 surrounding the respective movable permanent magnets 20. The clamps 36 may be secured together using nut-and-bolt type securing means 37, for example. The clamps 36 may also be attached to the movable permanent magnets using adhesive 38, for example.

In operation, switching the polarity of the current supplied to the fixed electromagnets 12 causes the electromagnets 12 to alternately attract and repel the movable permanent magnets 20. As is shown in FIG. 2, for example, all laterally adjacent poles of the movable permanent magnets 20 are opposed to each other (i.e., face in opposite directions), and all longitudinally adjacent poles of each of the movable permanent magnets 20 are opposed to each other (i.e., face in opposite directions).

The polarity of the fixed electromagnets 12 of each closed circuit are changed simultaneously so as to cause the movable permanent magnets 20 to be attracted and repelled so that they alternately move to the left and right in response to the magnetic forces. Because the movable permanent magnets 20 are physically connected to the linkage 21, which is connected to the movable power shaft 22, the power shaft 22 is moved to the left and right in response to the motion of the movable permanent magnets 20. The movable power shaft 22 is coupled by way of the flexible joint 25 to the cam assembly 31 of the drive shaft 30. The reciprocating linear motion of the movable power shaft 22 thus causes rotary motion of the drive shaft 30.

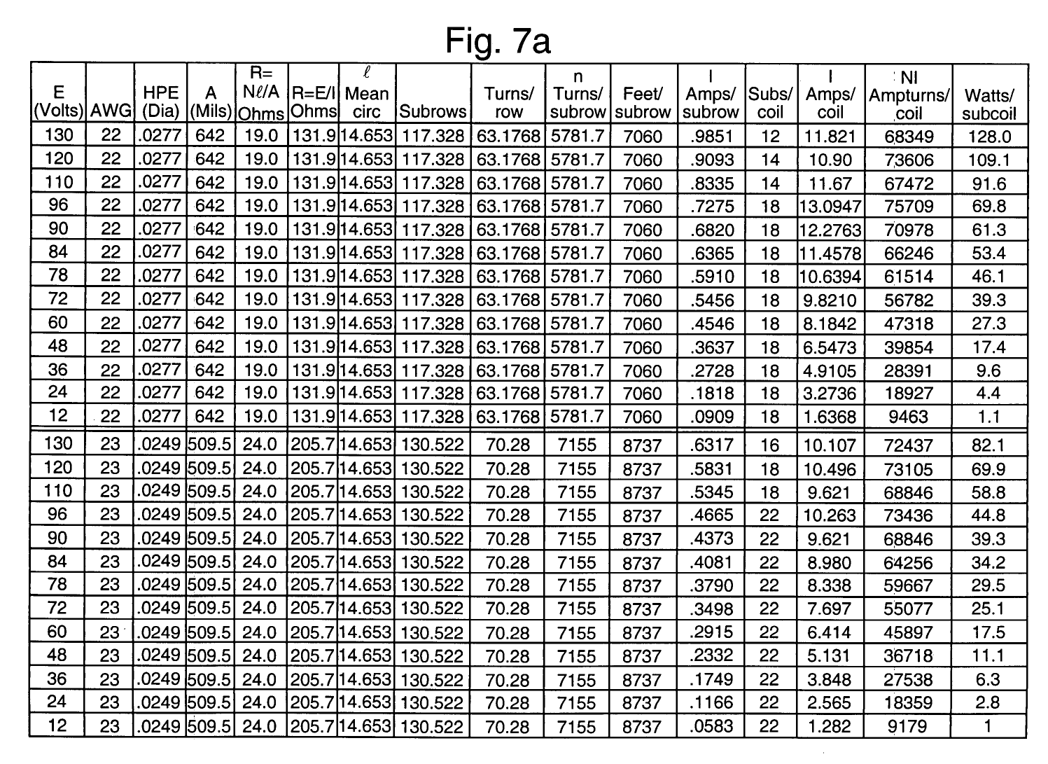

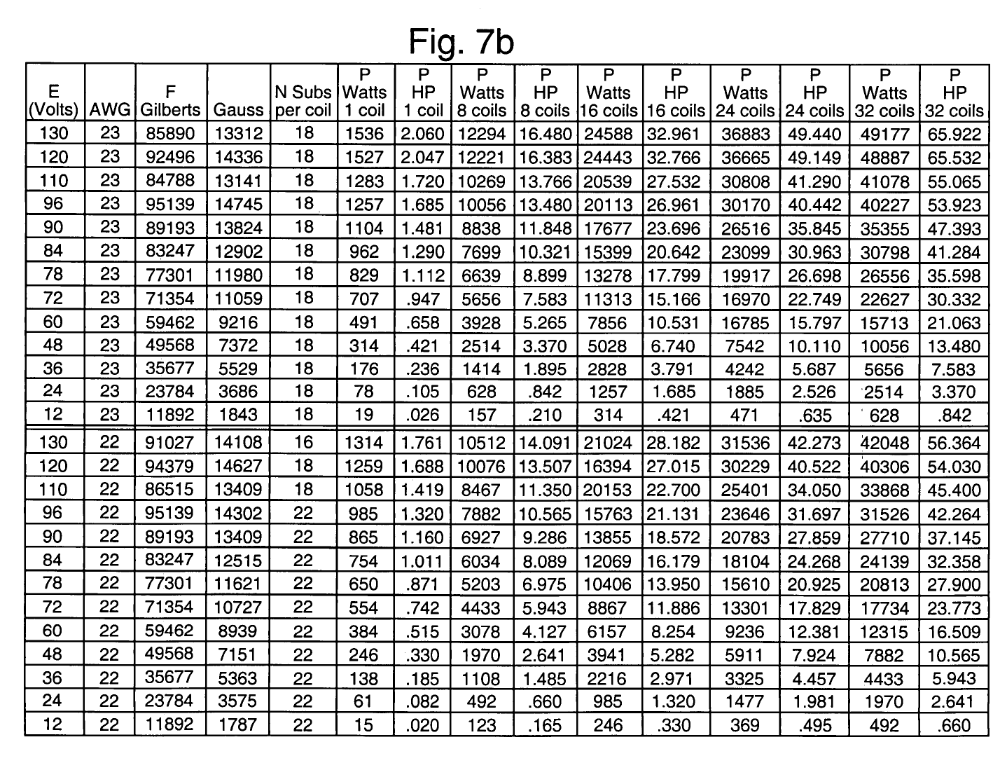

FIGS. 7a and 7b comprise a charts relating to input power supplied to the power generating apparatus 10. Equations used to determine the various values shown in FIGS. 7a and 7b are as follows. Substantially all of the equations used to derive the values listed in FIGS. 7a and 7b, are taken from “Standard Handbook for Mechanical Engineers”, Seventh Edition, edited by Marks and later by Baumeister, and published by McGraw-Hill Book Company. The first column of ohms values on FIG. 7a were taken from Standard Handbook for Mechanical Engineers for 1000 feet of a given AWG conductor at 149° F. The second column of ohms values were calculated by the following formulas R=nl/A, and R=E/I.

The number of turns per subrow (n-sub) is given by n. The number of turns per row is computed by (subcore width)/(HPE diameter). The number of rows (n) is computed by the coil diameter less the core divided by 2 divided by HPE diameter. The number of turns per subcore is the product of the number of turns per row times the number of rows time 0.78. The current per subcoil 14 is computed using the equation I=EA/nl. Amp-turns (NI) is computed using the equation NI=EA(n-sub)/l. F is calculated in Gilberts using the equation F=0.4πNI. Gauss is computed using the equation Gauss=F/6.452. Power (Watts) is computed using the equation P=E²A(n-sub)/nl. Horsepower (HP) is computed using the equation HP=Watts/746.

For example, the first exemplary data row of FIGS. 7a and 7b shows that, for an input voltage of 96 volts, using 23 AWG wire having a length of 8737 feet, and twenty-two (22) subcoils 14 per coil. Using one subcoil 14 requires about 44.8 watts of input power. Using eight coils requires about 7884.8 watts or about 10.569 horsepower of input power. Using sixteen coils requires about 15,769.6 watts or about 21.139 horsepower of input power. Using twenty-four coils requires about 23654.4 watts or about 31.71 horsepower of input power. Using thirty-two coils requires about 31539.2 watts and about 42.28 horsepower of input power.

In the motor 10, the fixed electromagnets 12 are energized using a plurality of subcoils 14 wrapped around each core 13, as opposed to a single coil disposed around each core 13. This is done so that reasonable wire gauge sizes may be used and the amount of current required for each subcoil 14 does not melt or overheat the subcoil 14.

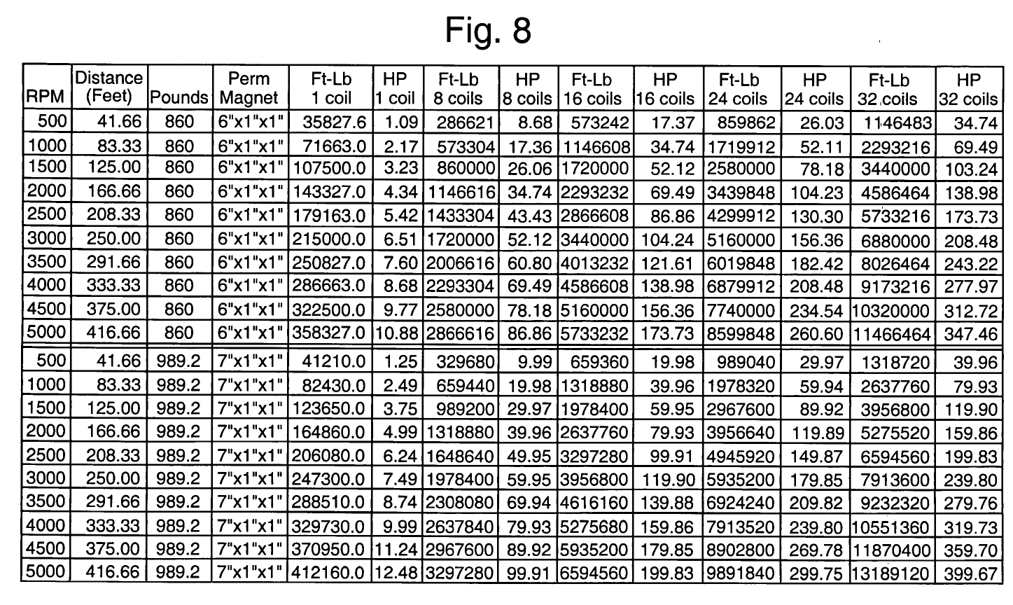

Referring to FIG. 8, it is a chart relating to output power generated by the power generating apparatus 10. The output power is a function of the sizes and strength of the movable permanent magnets 20, the number of subcoils 14 surrounding the fixed electromagnets 12, the number of amp-turns, the number of magnetic circuits 24 that are employed, and the RPM of the drive shaft 30. Thus, for example, if the drive shaft 30 is to rotate at a rate of 4000 RPM, using a single subcoil 14 and a 7″×1″×1″ movable permanent magnet 20, the movable permanent magnet 20 moves a distance of about 333.33 feet per minute, and generates about 329,730 foot-pounds of torque. This corresponds to about 9.99 output horsepower per single coil.

Using eight coils and the 7″×1″×1″ movable permanent magnet 20 generates about 2637840 foot-pounds of torque, which corresponds to about 79.93 output horsepower. Using sixteen coils and the 7″×1″×1″ movable permanent magnet 20 generates about 5275680 foot-pounds of torque, which corresponds to about 159.86 output horsepower. Using twenty-four coils and the 7″×1″×1″ movable permanent magnet 20 generates about 7913520 foot-pounds of torque, which corresponds to about 239.80 output horsepower. Using thirty-two coils and the 7″×1″×1″ movable permanent magnet 20 generates about 10551360 foot-pounds of torque, which corresponds to about 319.73 output horsepower.

It is to be understood that the charts and graph shown in FIGS. 7a, 7b, 8 and 9 illustrate some of the many possible values that may be selected for the components and operating parameters of the power generating apparatus 10. The disclosed values may vary depending upon application, such as selection of operating input voltage, wire size, magnet size, etc. For instance, the input voltages may be n the order of from 110-130 volts DC, and wire sizes may also vary accordingly. The selection of component sizes and values may readily be varied, subject to the desired size and power capacity of the motor 10. Thus, the present invention is not limited to the specific values that are disclosed in this specification and drawing figures.

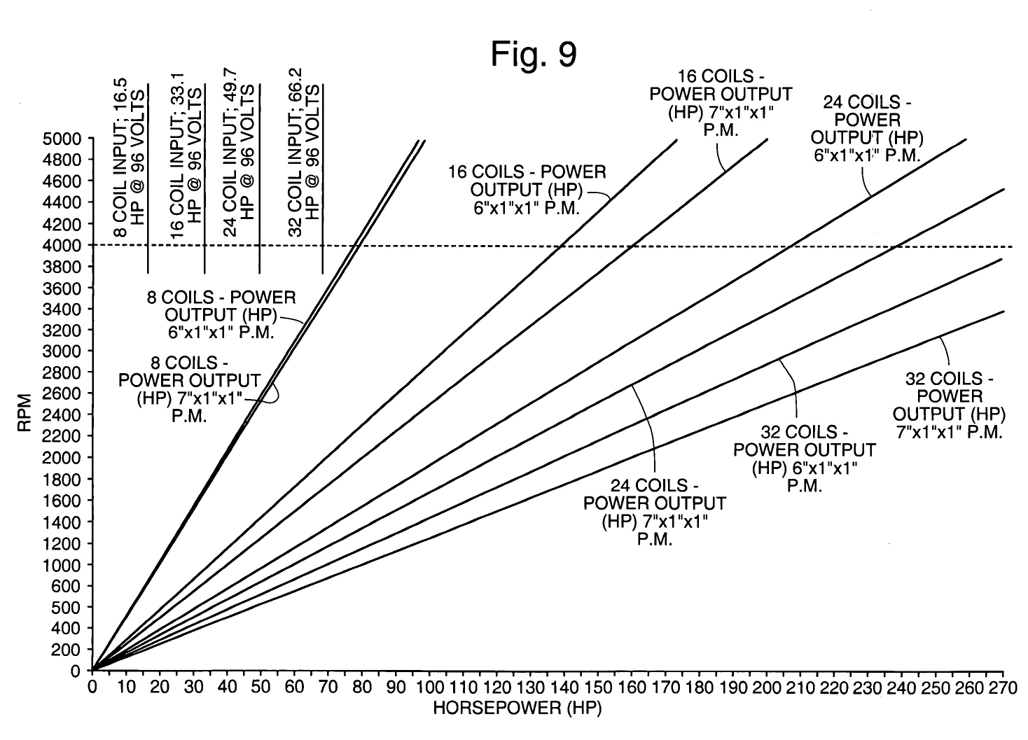

FIG. 9 is a graph showing RPM versus horsepower (HP) for different size permanent magnet 20 and subcoil 14 configurations. Vertical lines indicating input power requirements at 96 volts are shown at the upper left of the graph. The output power generated using various numbers of subcoils 14 for movable permanent magnets 20 having sizes of 6″×1″×1″ and 7″×1″×1″ are shown. For example, using sixteen subcoils 14 and a permanent magnet 20 with a size of 6″×1″×1″ requires input power of about 33 horsepower and produces an output power at 4000 RPM (illustrated by the horizontal dashed line) of about 138 output horsepower.

As should be clear from looking at FIG. 9, the power generating apparatus 10 generates a greater amount of output power than the input power necessary to energize the electromagnets 12 in any configuration. This is because the permanent magnets 20 comprise energy sources that are driven by the electro-magnets 12 to cause reciprocating motion that produces output power that is greater than the input power required to energize the electromagnets 12.

The magnetic motor 10 thus provides for movable permanent magnets 20 and fixed electromagnets 12 aligned in a linear fashion, to form a continuous magnetic field, and wherein polarities of the electromagnets 12 are switched to alternately change the polarity of the electromagnets 12 from north (N) to south (S) and vice-versa. This causes motion of the permanent magnets 20 in a back-and-forth reciprocating manner due to the alternating attractive and repelling forces that exist when the adjacent poles of the magnets 12, 20 are opposed or the same. The moving permanent magnets 20 are mechanically linked to the power shaft 22 which provides reciprocating mechanical output energy, or the drive shaft 30 contacts the cam assembly 31 so that reciprocating motion of the permanent magnets 20 causes rotary motion of the drive shaft 30.

The plurality of subcoils 14 disposed around each core 13 are electrically wired in parallel and are installed in series along the core 13. The permanent magnets 20 are preferably employed in pairs. The permanent magnets 20 are disposed having like poles facing like poles of longitudinal adjacent permanent magnets 20. The electromagnets 12 are disposed having like poles facing like poles of longitudinal adjacent electromagnets 12. The electromagnets 12 are disposed in fixed positions with the movable permanent magnets 20 aligned along the axis of the electromagnets 12. The Gauss produced by the permanent magnets 20 should be substantially the same as the Gauss produced by the electromagnets 12 to optimize performance. The polarities of the electromagnets 12 of each closed magnetic circuit are switched at the same time. The variable voltage regulator 42 controls the speed of the motor 10. The voltage regulator 42 controls the amount of input power applied to the motor 10, and thus the amount of output power produced by motor 10. The commutator 43, photo-switch 47 or an electronic switching device 47 changes polarity of all electromagnets 12 at the end of each stroke in each closed magnetic circuit.

Input power in horsepower is calculated using the equation P=IE÷746. That is: power=(amps×volts)÷746. Output power in horsepower is calculated using the equation (average constant force×distance×time (foot-pounds))÷33,000. When the output horsepower is greater than the input horsepower, then an over unity condition is present and excess output power can be harvested or used for desired purposes.

The DC input power supplied by the power source 40 induces power in the metallic core 13 by creating a magnetic field around the metallic core 13 thereby creating a magnetic pole at each end of the core 13 with one end as the north pole and the other end as the south pole. The ability to change the polarity (direction of magnetic flow) from north to south to north to south, etc. for each pole 13 is a vital function of the present invention. In addition, the electromagnets 12 essentially operate as tractive electromagnets 12 which are designed to exert a force on a load (the fixed permanent magnets 20) through some distance and thus do work.

Gauss is defined as the magnetic flux density of the number of magnetic lines of force per square centimeter per cross-sectional area of a pole. F is the magnetic lines of force (0.4πNI) measured in gilberts. NI is the number of wire turns times the number of amperes passing through each subcoil 14.

It is desirable to provide Gauss in the electromagnet 12 (the metal core 13 inside the subcoils 14) equivalent to the Gauss in the movable permanent magnets 20. To accomplish this requires multiple coil windings on each electromagnet core. NI increases with an increase in the number of turns or amps. To produce enough NI to match the Gauss of the permanent magnets 20 requires mutual induction of multiple subcoils 14 around each electromagnet core. To accomplish this requires that each subcoil 14 be wired in parallel and function in series around any given electromagnet core.

Using this technology produces the desired Gauss from the electromagnets 12 and makes possible the harvesting of the stored energy in the permanent magnets 20. This process provides positive movement of the movable permanent magnets 20 and it is this movement that delivers the power that turns the drive shaft 30.

The permanent magnets 20 supply most of the output power, and the permanent magnets 20 require no additional energy. It is the electromagnets 12 that require an external energy source. The present invention generates more output power from the drive shaft 30 than is required to operate the electromagnets 12. The term unity means that the input energy equals the output energy, and the term over-unity is used to express the fact that there is more energy output than energy input.

When the output horsepower equals the input horsepower required for the electromagnets 12, a unity condition has been reached. When the output power exceeds the input power then an over-unity condition has been reached. This is illustrated in FIGS. 7a, 7b, 8 and 9, which clearly shows that the present invention generates more output power than required input power.

It might be believed that this over-unity condition is impossible because it violates the law of conservation of energy. However, the present invention does not violate the law of conservation of energy. This is because the permanent magnets 20 provide a substantially limitless source of energy, i.e., its magnetic field.

By way of example, and referring to FIGS. 7a, 7b, 8 and 9, the amount of electrical energy that is input to induce magnetic lines of force in all of the cores 13 of the electromagnets 12 is the total input power. The input power (FIGS. 7a, 7b) for 8 coils of 22 AWG wire at 110 volts and 11.67 amps per coil is given by the equation (P=IE)÷746=(8*110*11.67)÷746=10269.6 watts÷746=13.776 HP. The output power (FIG. 8) produced by the present invention at 2,000 RPM using 7″×1″×1″ size permanent magnets 20 and the above-calculated input power is equal to ((989.2 lbs)*(166.66 ft)*8)÷33,000=1,318,880÷33,000=39.96 HP. Thus, the output power minus the input power is 39.96 HP−13.776 HP=26.184 HP (net generated horsepower not taking friction or other dissipating forces into account), and the present invention operates in an over-unity condition.

Thus, power generating apparatus comprising a permanent magnet motor that converts magnetic energy into mechanical energy have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. Magnetic power generating apparatus comprising:
a closed magnetic circuit that comprises a plurality of fixed electromagnets that each comprise a magnetizable core and a plurality of subcoils disposed around the magnetizable core, and a plurality of movable permanent magnets having north (N) and south (S) poles interposed between adjacent fixed electromagnets, which movable permanent magnets comprise a power source for the power generating apparatus;
a linkage interconnecting the plurality of movable permanent magnets;
a movable power shaft connected to the linkage;
an output drive shaft comprising a cam assembly that contacts the movable power shaft;
a power source;
energizing circuitry coupled to the power source and the plurality of subcoils for energizing the subcoils so that the electromagnets alternately provide north (N) and south (S) poles adjacent to the north (N) and south (S) poles of the movable permanent magnets to alternately attract and repel the movable permanent magnets; and
current generating circuitry coupled to the drive shaft and the energizing circuitry for generating current in response to rotation of the drive shaft.

2. The apparatus recited in claim 1 wherein the movable permanent magnets, fixed electromagnets, and energizing circuitry cooperate to cause each pole of each movable permanent magnet to produce work at essentially all times.

3. The apparatus recited in claim 1 wherein the closed magnetic circuit comprise a plurality of closed magnetic circuits.

4. The apparatus recited in claim 1 further comprising a plurality of closed magnetic circuits disposed around the output drive shaft in a symmetrical balanced manner.

5. Magnetic power generating apparatus comprising:
a rotatable output drive shaft comprising a cam assembly;
a closed magnetic circuit that comprises a plurality of fixed electromagnets that each comprise a magnetizable core and a plurality of subcoils disposed around the magnetizable core, and a plurality of movable permanent magnets having north (N) and south (S) poles interposed between adjacent fixed electromagnets, which movable permanent magnets comprise a power source for the power generating apparatus;
coupling means for coupling the plurality of movable permanent magnets to the cam assembly and which causes rotary motion of the drive shaft in response to reciprocating linear motion of the of movable permanent magnets;
a power source;
energizing circuitry coupled to the power source and the plurality of subcoils for energizing the subcoils so that the electromagnets alternately provide north (N) and south (S) poles adjacent to the north (N) and south (S) poles of the movable permanent magnets to alternately attract and repel the movable permanent magnets to cause them to undergo reciprocating linear motion; and
current generating circuitry coupled to the drive shaft and the energizing circuitry for generating current in response to rotation of the drive shaft.

6. The apparatus recited in claim 5 wherein the coupling means comprises:
a linkage interconnecting the plurality of movable permanent magnets; and
a movable power shaft coupled between the linkage and the cam assembly.

7. The apparatus recited in claim 5 further comprising a nonmagnetic housing.

8. The apparatus recited in claim 7 wherein the nonmagnetic housing comprises aluminum.

9. The apparatus recited in claim 5 wherein the nonmagnetic housing comprises stainless steel.

10. The apparatus recited in claim 5 wherein the movable permanent magnets comprise neodymium.

11. The apparatus recited in claim 5 wherein the closed magnetic circuit comprise a plurality of closed magnetic circuits formed as a multi-dimensional array.

12. The apparatus recited in claim 5 further comprising a plurality of closed magnetic circuits disposed around the output drive shaft in a symmetrical balanced manner.

13. Magnetic power generating apparatus comprising:
a closed magnetic circuit that comprises a plurality of fixed electromagnets having a magnetizable core and a plurality of subcoils disposed around the magnetizable core, and a plurality of movable permanent magnets having north (N) and south (S) poles interposed between adjacent fixed electromagnets, which movable permanent magnets comprise a power source for the power generating apparatus;
a movable power shaft connected to the plurality of movable permanent magnets;
a power source;
energizing circuitry coupled to the power source and the plurality of subcoils for
energizing the subcoils so that the electromagnets alternately provide north (N) and south (S) poles adjacent to the north (N) and south (S) poles of the movable permanent magnets to alternately attract and repel the movable permanent magnets to cause them to undergo reciprocating linear motion and in cause reciprocating motion of the movable power shaft; and
current generating circuitry coupled to the energizing circuitry for generating current in response to motion of the power shaft.

14. The apparatus recited in claim 13 further comprising a rotatable drive shaft having a cam assembly coupled to the power shaft, and wherein reciprocating motion of the movable permanent magnets causes reciprocating motion of the power shaft resulting in rotary motion of the drive shaft.

15. The apparatus recited in claim 13 wherein the closed magnetic circuit comprises two parallel axes along which cores of the plurality of fixed electromagnets and plurality of movable permanent magnets are disposed, such that the plurality of movable permanent magnets are aligned parallel to each other.

16. The apparatus recited in claim 15 wherein poles of each parallel permanent magnet have opposite polarity.

17. The apparatus recited in claim 15 wherein the plurality of subcoils are wired in parallel and are disposed in series around the magnetizable core so as to mutually induce a magnetic field in the fixed electromagnets that is comparable to the magnetic field of the permanent magnets.

18. The apparatus recited in claim 15 wherein the plurality of subcoils are wired in parallel and are disposed in series around U-shaped magnetizable cores so as to mutually induce a magnetic field in the fixed electromagnets that is comparable to the magnetic field of the permanent magnets.

19. The apparatus recited in claim 13 wherein the magnetic fields generated by the permanent magnets and electromagnets cooperate to generate linear reciprocating motion of the power shaft.

20. The apparatus recited in claim 14 wherein the cam assembly comprises cam lobes that balance forces on the drive shaft derived from movable power shafts disposed on opposite sides of the drive shaft.
